(19) United States
(12) Patent Application Publication
(10) Pub. No.: US 2007/0036178 A1
(43) Pub. Date: Feb. 15, 2007

(54) Layer 2 virtual switching environment

(76) Inventors: Susan Hares, Saline, MI (US); Joseph Chen, Fremont, CA (US); Choon Lee, Palo Alto, CA (US); Ravi Manghirmalan, Fremont, CA (US)

Correspondence Address: PERKINS COIE LLP, P.O. BOX 2168, MENLO PARK, CA, 94026, US

(21) Appl. No.: 11/347,834

(22) Filed: Feb. 2, 2006

Related U.S. Application Data
(60) Provisional application No. 60/649,482, filed on Feb. 2, 2005.
(60) Provisional application No. 60/650,435, filed on Feb. 3, 2005.

(51) Int. Cl. H04J 1/00; H04J 3/04

(52) U.S. Cl. 370/490; 370/535

(57) ABSTRACT

A Virtual Communication Environment to support virtual switching engines for layer 2 switches is described. The virtual layer 2 switching engines allow many virtual switches to be created in a CPU or across multiple CPUs in switching hardware. The virtual switch engines reduce the inter-communication costs in memory, CPU, inter-process bandwidth, and fabric bandwidth. This reduction in the cost per Virtual Switch device allows either more virtual switches to be contained within a control plane or more applications per switch control plane.

### CLAIM OF PRIORITY AND CROSS REFERENCE TO RELATED APPLICATIONS

This application claims priority to U.S. Provisional Patent Application No.: 60/649,482 entitled LAYER 2 VIRTUAL SWITCHING ENVIRONMENT, filed Feb. 2, 2005, inventors Hares, et al., attorney reference: 41434-8016.US00; U.S. Provisional Patent Application No. 60/650,435 entitled VIRTUAL SWITCHING ENVIRONMENT, filed Feb. 3, 2005, inventors Hares, et al., attorney reference: 41434-8017.US00; U.S. Utility Patent Application No.: 11/121,162 entitled VIRTUALIZATION OF CONTROL SOFTWARE FOR COMMUNICATION DEVICES, filed May 2, 2005, inventors Hares, et all, attorney reference 41434-8009.US01; and U.S. Provisional Patent Application No. 60/567,358, filed Apr. 30, 2004, entitled VIRTUALIZATION OF CONTROL SOFTWARE FOR COMMUNICATION DEVICES, inventors Hares, et al., attorney reference: 41434-8009.US00, all of which are hereby incorporated by reference in their entirety.

### FIELD OF INVENTION

Virtualization engines for software for communication devices

### DESCRIPTION OF RELATED ART

Communication of phones, laptops and cell phone over a network is part of daily life for North America, Europe and Korea. The demand for more bandwidth and network devices continues to grow. Moore's law suggests a limit to how fast hardware can grow.

Virtualization software enables one physical device to become 10 or 100 logical devices. This type of instant growth provides a way around the limits in hardware growth. End system users are focused on VM Ware 4.0 or VPC2004. The virtualization of end systems is based on some knowledge of what are critical systems for applications and what systems can wait.

Network communication software is that aids in communication over the network. Communication software may pass data, voice, multi-media or signaling. The data traffic can switched at layer 2 or routed at layer 3 or application forwarding at layer 4. Network software has constraints on timing, data throughput and processing required that make virtualization requirements different than normal PC management. Virtualization of communication software may start from the software built to handle networks.

Traffic Switched at layer 2 is based on frames of data with MAC headers. These frames are passed across Local Area Media (LAN). Examples of LAN technology include (but are not restricted to) Ethernet hardware (LAN) or 802.11 wireless hardware (WLAN). Many types of media can be inter-connected via the IEEE 802.1D architecture that provides either MAC level bridging or LLC bridging based on 802.1 protocols (Spanning Tree, Rapid Spanning Tree, and Multiple Spanning Trees).

A layer 2 bridge participates with other Layer 2 bridges to calculate a spanning tree that will provide consistent forwarding of MAC address frames toward a destination. Each bridge then creates a layer 2 Forwarding Information Base (FIB), This Layer 2 FIB indicates what interface or interfaces a frame with MAC address headers will be forwarded on.

Networks are formed by the interconnection of LANs and Wide-Area Networks (WAN). A communication device operates on a network to perform some application. Many network are connected together via the Internet. Let's examine the Internet.

Information in the Internet is transmitted as packets. A packet in the Internet is a fixed-length piece of data that is individually routed hop-by-hop from source to destination. The action of routing a packet means that each router along the path may examine header information in the packet and a local database in order to forward the packet to its next hop.

This local database is typically called the Forwarding Information Base or FIB. Entries in the FIB, usually structured as a table, determine where packets are to be forwarded. The FIB is derived from a collective database called a Routing Information Database or RIB. This RIB is a collection of all the routing information the router “knows”; an algorithm maps the entries (routes) in the RIB to those in the FIB, which is used for forwarding.

The RIB is built in two ways, which may be used together: (a) static configuration, and (b) dynamic routing protocols. These protocols may be further subdivided into two groups based on the part of the Internet in which they operate: exterior gateway protocols, or EGPs, are responsible for the dissemination of routing data between autonomous administrative domains, and interior gateway protocols, or IGPs, are responsible for dissemination of routing data within a single autonomous domain. Furthermore, two types of IGPs are in widespread use today: those that use a distance-vector type of algorithm and those that use the link-state method. This patent concerns an the application of an algorithm to optimize a computation performed in the operation of link-state IGPs.

A communication device operates on a network to perform some application. Let's examine a few common network devices running an application: firewalls, route-servers, network-access devices and network-management devices.

Firewalls are network devices that run a security analysis on the traffic that is passed through them. Route-Servers are devices that store routes from many different networks and upon request provide information about these routes. Network Access devices provide local access to a network via a particular type of physical interface such as Ethernet, Dial-up, or long-haul circuits.

Network Management devices monitor and configure the network. The network manager may monitor a network for failures (faults) or performance (how many packets) or accounting issues (login access by customer or security attacks).

Virtual Communication Devices

Virtual Devices need to scale to hundreds virtual communication devices inter-communication across a network. Communication devices include (but are not limited to) routers, switches, firewalls, gateways, network access devices, telephony devices, router-servers, network security devices.

A brute force approach to virtual communication entities is to simply create multiple processes in an operating system utilizing external links between the processes across socket boundaries. Virtual communication systems based on the brute force require processing power and memory per running process plus resources to provide the communication between processes. If each process is interconnected with every other process, the required memory and processing grows exponentially.

Scaling of such virtual communication systems can be done more efficiently but requires the following components:
Efficient detection and interconnecting virtual systems,
Full mesh interconnection of processes or double forwarding of information between processes via an interconnection process,
Reliable forward if the operating systems do not support reliable forwarding,
Recovery from device failure (or partial failure) via network methods (graceful restart within protocols) or quick recovery from other virtual routers,
Simple management of large numbers of virtual routers, and
Canonical interfaces to the virtual communication system for easy integration with existing applications or communication protocols.

The Virtual Routing Environment invention (U.S. patent application Ser. No.: 11/121,162) provides algorithms for communication environment to solve these issues. Diagram 1 provides an example of the Virtual Communication Environment found in the Virtual Routing. Within this architecture multiple VR engines may exist to perform different applications. Applications can be virtual routing, firewall, network management agent, virtual MPLS switch, or a virtual switch. The virtual switch can be a unified switch for Wired and Wireless.

Diagram 1 shows four types of virtual engine modules:
Type 1: vEngine that talks to a vrClientManager
   vrClient1 (100), and vrClient2 (110)
Type 2: vEngine (vrClient3 [120] that talks to a vrMgr
Type 3: vrClientManager1 [140],
Type 4: vrMgr [150]

These four types of virtual routing engines allow several types of hierarchy within the virtual communication environment for different applications.

Diagram 2 shows the same virtual engine with a set of applications for virtual switching. The applications are provide an illustration of one embodiment of the virtual communication environment from the Virtual Routing Environment invention.

Client 1 contains vtasks [208] applications for:
Stacking application [201]
STP-RSTP application [202] that supports both spanning tree and Rapid Spanning Tree,
MAC Manager application that manages MAC addresses learned or set on ports [203],
Port Manager application that manages physical ports[204],
Trunk Manager application that manages port groupings as trunks manually or via LACP protocol [205], and
VLAN manager than manages VLANs on the switch [206],
Hardware Abstraction Layer (HAL) control task[207].

The Hardware abstraction layer task may manipulate the configuration and status of the HAL layer. The Hardware abstraction layer provides an abstraction layer on top of drivers that directly interface to the hardware. Diagram 3 shows how the HAL provides a layer between the control-plane processes for a virtual switch and the OS and kernel interfaces for the same virtual switch unit. The Hardware abstract layer allows the software to operate over any mix of device drivers and hardware.

Client 2 contains the same virtual switching application tasks (stacking [211], STP-RSTP application [215], MAC manager [216], Port Manager [217], Trunk Manager [218], VLAN manager [219], and HAL control task [220]) plus the virtual switching applications for:
GMRP [212],
GVRP [213], and
802.1x [214].

Client 3 [230] contains applications to process snooping of layer 3 multicast packets (IGMP snooping [232], PIM-Snooping [233]) and Layer 3 DHCP packets [234] plus applications to handle stackable switches [231].

vrClientManager [240] contains client Manager applications for: stackable switch [241], switch configuration [242], IDS/IPS Management [243], ACL Management [244], Spanning Tree Management [245], and VLAN management [246].

vrMgr [250], contains management cycles for security processes across the switch (ACL management [251], IDS/IPS [252], Layer-3 Snooping Manager [253], Radius/802.1x Manager [254], and Stacking Manger [255].

The Virtual Communication Environment (VCE) reduces data flow between tasks that run as a virtual task on virtual communication client (vrClient) or vrClientMangers or VrManagers. The vrlPC communication between
vrClient1 [209] and vrClientMgr [246], or
vrClient2 [223] and vrClientMgr[246], or
vrClient3 [238] and vrMgr [256]
   may pass across the most efficient method of passing between the two processes. These methods may include: OS based IPC, event calls based on shared memory, or an IPC tuned for the virtual environment.
   Virtual Switching Requirements

Virtual Switches may replace single or multiple physical switches. The multiple physical switches can be in separate boxes across a network. The multiple physical switches may also be connected an optical connection or across a switch fabric.

Virtual Switches may replace stacked physical switches. Virtual Switches may stack and forwarding internally to logical ports. Virtual Switches may also support combining traffic of exterior ports. Efficient Virtual switches may scale to 100's of virtual switches require the same communication framework as other virtual communication systems.

Let's examine in detail the requirements for stacking, internal forwarding, and combing of exterior ports in a virtual switch.

a) Stacking of Virtual Switches

Layer 2 switches can contain hundreds of ports on a single switch. Current hardware stacks individual switch modules into groups of modules with interconnections between the modules to provide redundancy. The term “stack” arises because these modules may be physically stacked above one another.

A virtual environment needs to allow logical stacking of switches to replace the physical stacking of switches. In this way, hardware groups of ports can be stack in varying groups of ports. The ports in particular hardware chassis may be mapped into a logical scheme that allows movement or grouping of ports. The logical port mapping may be available to the switch to determine internal switch pathways. The virtual stackable switch may track actual hardware, configuration of each virtual switch unit and stackable switch configuration for all virtual switches.

b) Internal Forwarding of Stackable Switches

Forwarding within a virtual switch for a Layer 2 frame directs the frame on a path across the switch fabric. Switch fabric rules may select:
Shortest path between switch forwarding units,
Run through a set of security processor, or
Travel down traffic engineered pathways to minimize delay.

Transmitting multicast frames may require that the frame be transmitted to all virtual switches or it may restrict broadcast frames to certain port distribution.

The internal forwarding mechanisms require the management application store information about the virtual switch unit topology, the hardware ingress ports and egress ports, and the fabric path between these ports. For security, additional paths through the fabric are maintained to allow for:
Direct port switching,
Mirror ports for security to another port, or
Discard the packet (at ingress or egress), or
Restrict broadcast frames.

Fast knowledge of changes in the physical and virtual switch topology allow path selection algorithms to pro-actively switch traffic paths along new pathways or away from failed pathways. Fast algorithms allow virtual switches to provide fast fail-over for high-availability of paths.

Internal switch path selection algorithms vary from fixed pre-determined pathways to highly dynamic path selection. Fixed pre-determined such as the preset cascading of traffic to fail-over ports requires the fail-over ports be allocated permanently. Software switching may allow back-up ports to be minimized.

c) Combining External Ports into a Trunk

Modern switches use a concept of a ‘trunk’ or ‘trunk connection’. A trunk allows a set of parallel paths from a remote unit to a multiplicity of ports. The multiple parallel paths are considered one logical path. A trunk connection between two units allows the total bandwidth available for the trunk to be approximately the aggregate of the bandwidths available to each of the ports which are ‘members’ of the trunk connection.

However, with the development of stackable units it is also desirable (and known practice) to make ports of different units within a stack members of the trunk. This presents some difficulties to internal set-up of a logical pathway within a switch or a stackable switch. The virtual switch may be able to identify members of the trunk.

Rules form a policy for forwarding of frames within the trunk pathways. These rules for forwarding enforced by stackable switch logic may handle traffic from ports that are:
Connected to the same trunk,
Not connected to a trunk (or non-trunk port).
Connected to a different trunk.

The rules may be augmented to restrict traffic to a single virtual switch or to a group of virtual switches. Restriction of traffic to a single switch or a single stack may be denoted as a ‘local forwarding’ rule. Another rule may deal with destination MAC addresses that are unknown on the originating unit and forwarded to other trunks for delivery or dropping. It is necessary to determine when such a packet is received by way of the cascade from the originating unit whether it has been forwarded to a specific trunk so as to prevent a second forwarding of the packet to the same trunk.

Broadcast traffic or multicast traffic may have additional rules governing transmission. Broadcast or Multicast frames are often utilized in network security attacks such as port scanning or icmp attacks. Current and planned hardware supports restriction of these frames to particular ports and/or trunks. Virtual switching may support this restriction.

Exchange of the detection of units as well as the policy governing the forwarding paths is key to flexible virtual switches.

Existing Work on Virtual Switches

Existing patents and patent application deal with switching of MAC level frames do not deal with the methods of the virtual switching environment.

Two patents deal with the VLAN environment across the network or switch fabric.
1. “Multiple VLAN architecture system”—U.S. Pat. No. 6,035,105 (Mar. 7, 2000), Keith McCloghrie, Bernard R. James, Chrstopher Young, Norman W. Finn
2. “Virtual Switching for Interconnected networks” U.S. Pat. No. 6,434,156 (Aug. 13, 2002), Chaing Yeh.

The “Multiple VLAN architecture system” deals VLAN architecture, VLAN identifiers in frames, forwarding concepts, management protocols, VLAN trunk advertisement protocols, and VLAN configuration server protocols. These protocols do not address stackable switches or virtual stackable switches.

“Virtual switching for Interconnected Networks” deals with establishing the VLAN identifiers in frames that can be set between switches interconnected by a layer 3 network. Virtual Switching deals two concepts: switching between one Virtual Omni-switch devices (VOSR) to a second VOSR on a different network. Between these VOSR, the algorithms creating virtual tunnel by glue together data pipes through public and private networks. This virtualization is the virtualization of network connection between two devices by glue together pipes.

This invention creates a virtual control plane to control plane intercommunication to direct the data path via the hardware forwarding rules. This invention does not deal with create virtual pipes between switches through public or private networks, nor the packet additions to support these virtual pipes.

### SUMMARY OF THE INVENTION

This invention is a method for a Virtual Communication Environment to support virtual switching engines (VSE) for layer 2 switches. The virtual layer 2 switching engines allow many virtual switches to be created in a CPU or across multiple CPUs in switching hardware. The virtual switch engines (VSE) with reduces the inter-communication costs in memory, CPU, inter-process bandwidth, and fabric bandwidth. This reduction in the cost per Virtual Switch device allows either more virtual switches to be contained within a control plane or more applications per switch control plane.

The virtual switches configurations include, but are not limited to, the following hardware deployments with:
a single piece of hardware chassis to create multiple virtual switches,
run across multiple pieces of hardware connected across a network to create virtual switches out of ports from different hardware chassis,
run on hierarchical grouping of switch chassis across an optical or switch fabric,
run virtual switching engines with virtual routing engines in firewall configuration, and
run virtual switches with security motivated sampling and processing.

The virtual layer 2 virtual engines may work as stackable switches that work together as a single coherent cluster unit or as multiple independent virtual switches.

### BRIEF DESCRIPTION OF THE DRAWINGS

FIG. 1 is a diagram of a Virtual Communication Framework with virtual Tasks.

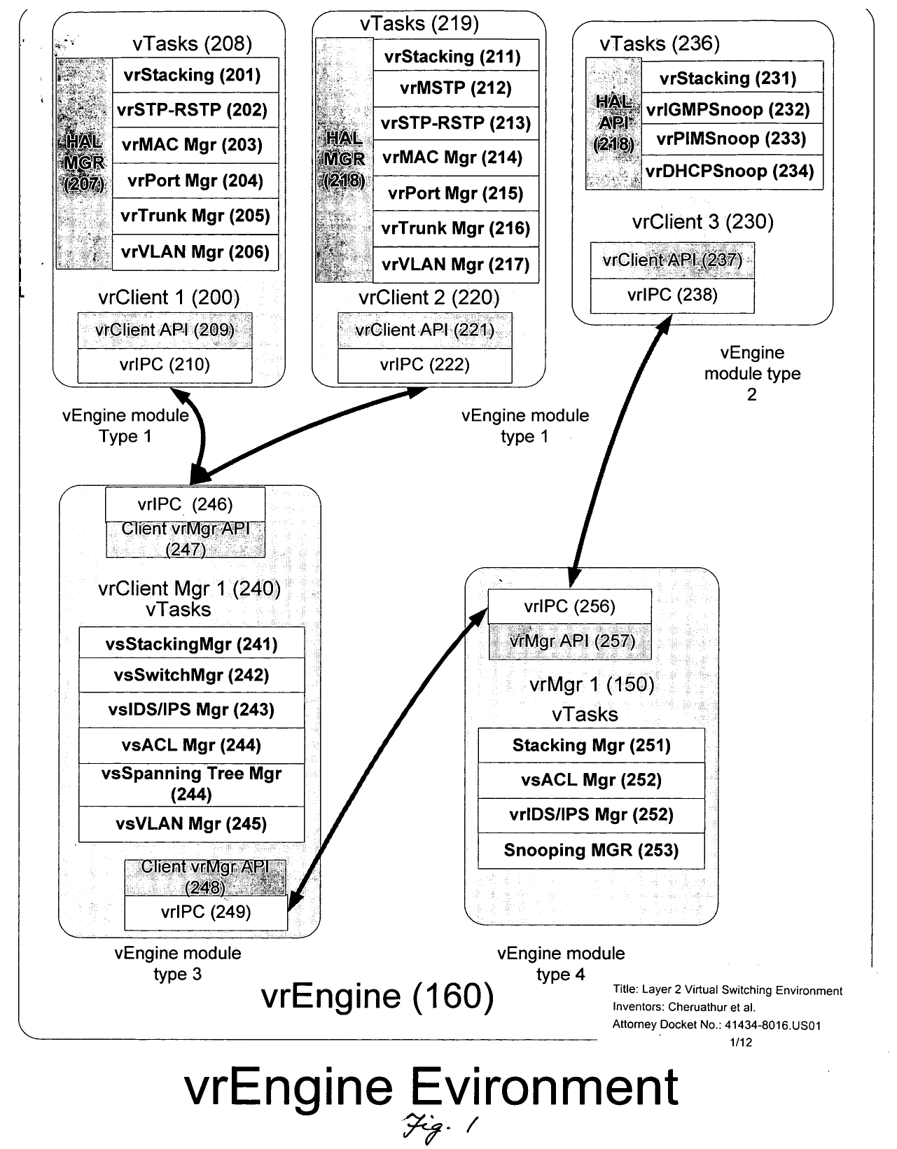

FIG. 2 is a diagram of a Virtual Communication Environment with Virtual Switching Tasks.

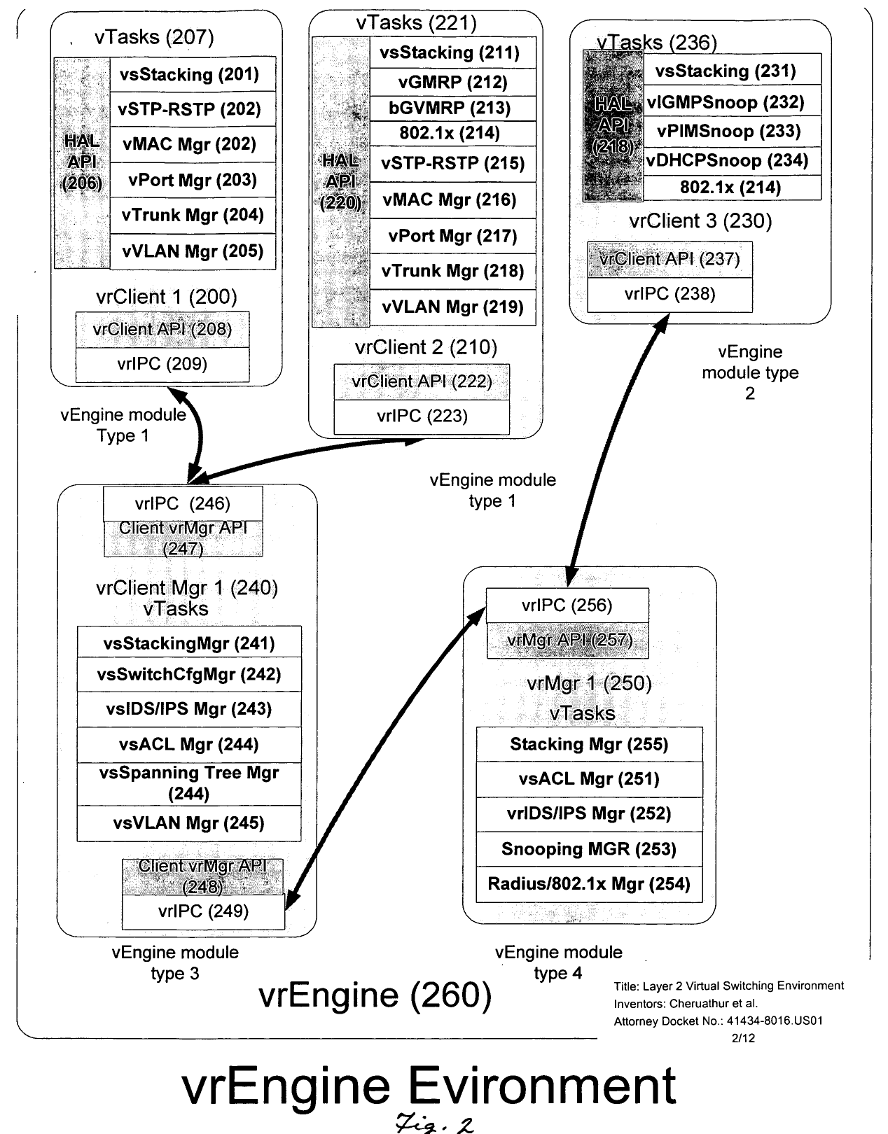

FIG. 3 is a diagram of a Virtual Switching Environment—Single virtual unit.

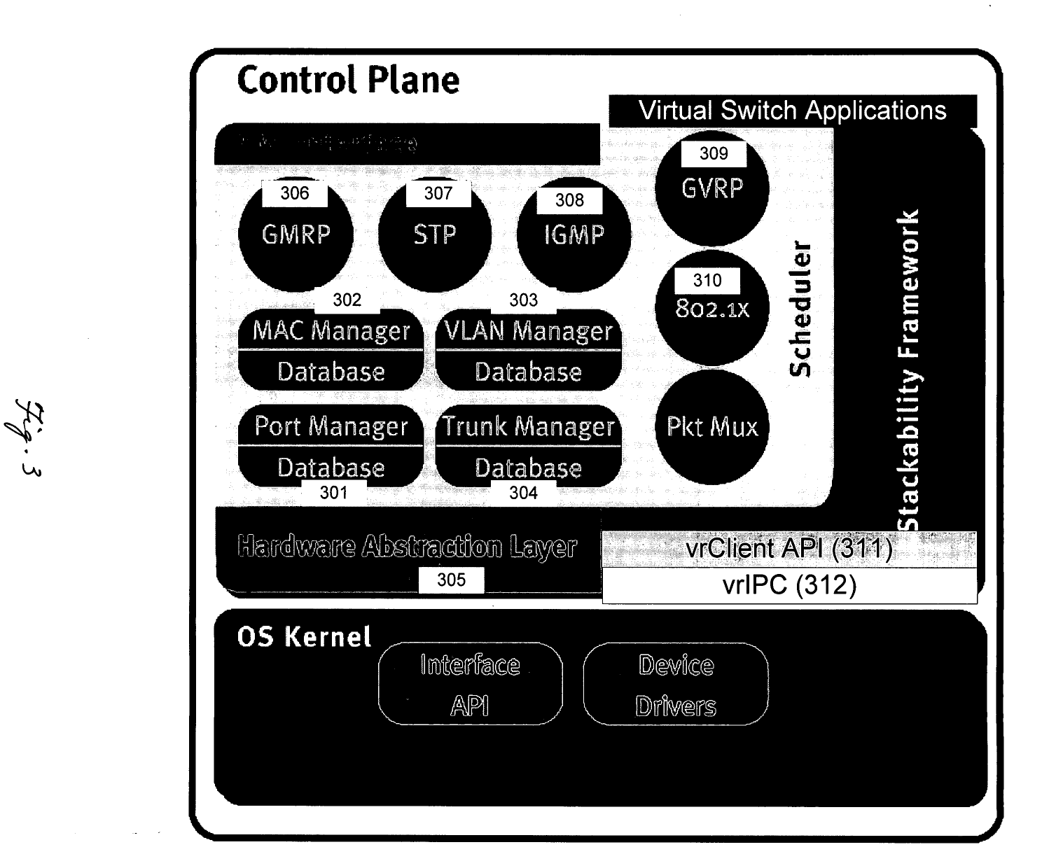

FIG. 4 is a diagram of a Virtual Software Switches in Different Communication Patterns.

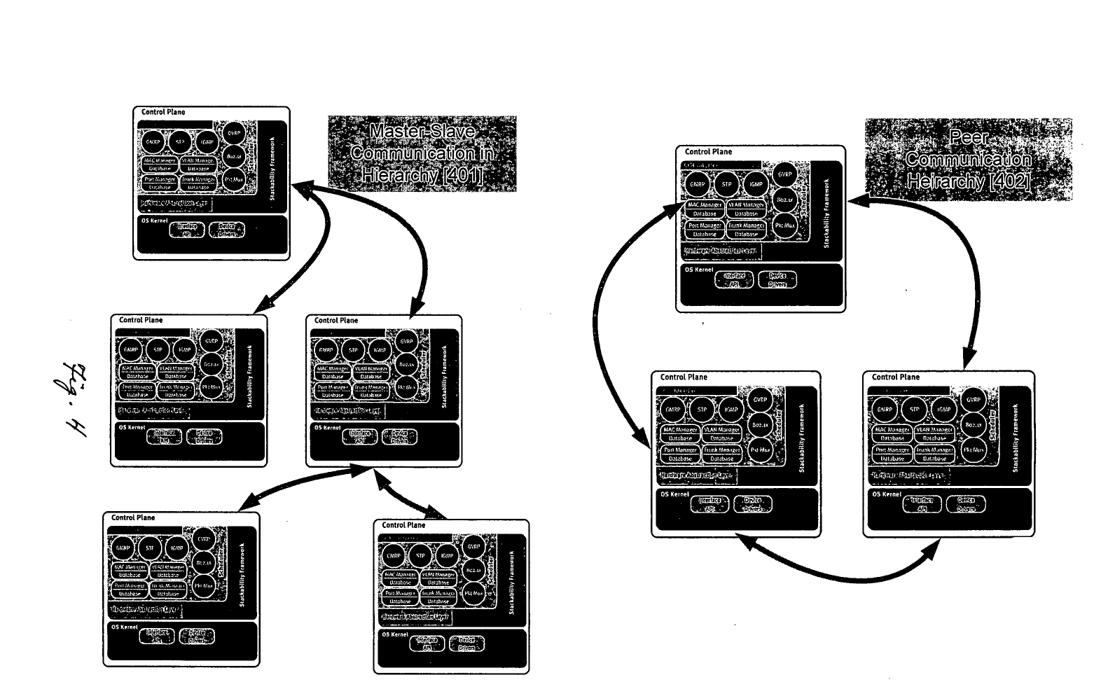

FIG. 5 is a diagram of a Hardware Abstraction Layer (HAL) internal structure.

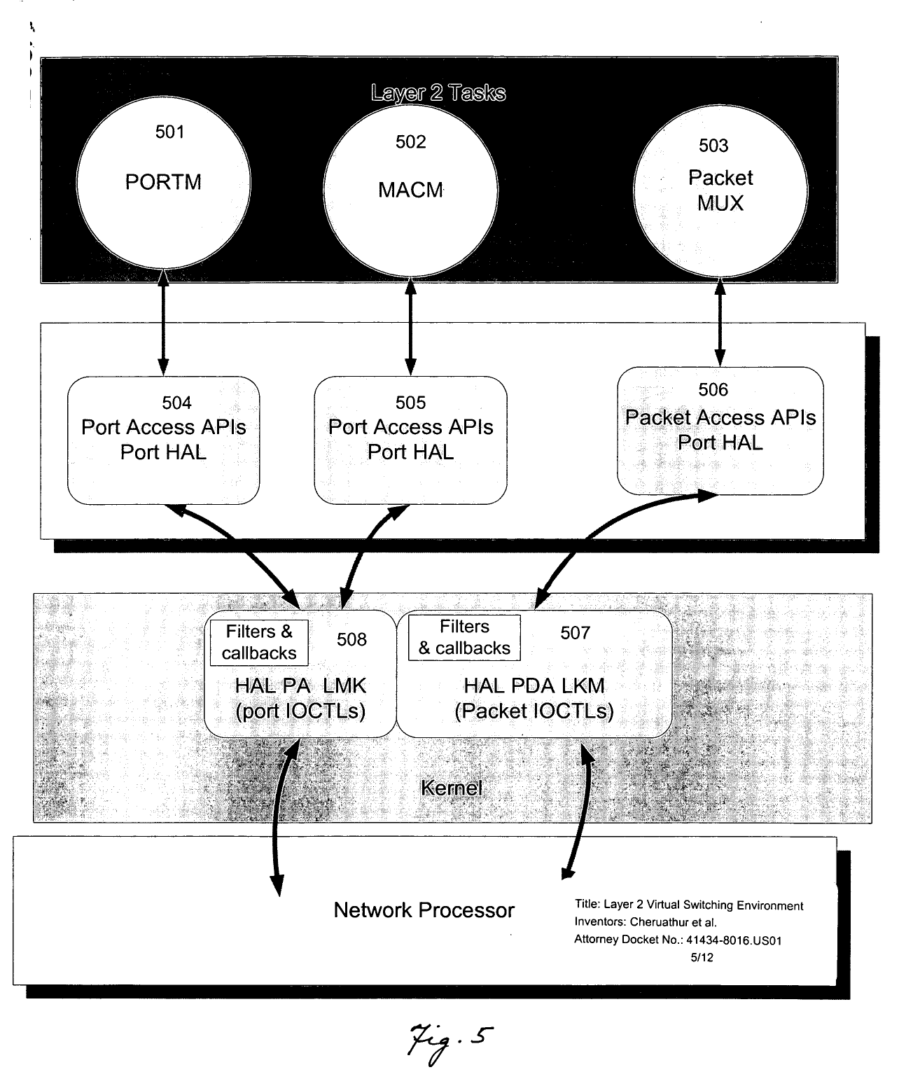

FIG. 6 is a diagram of a L2/L3 interaction with Virtual Switch Environment HAL Abstraction.

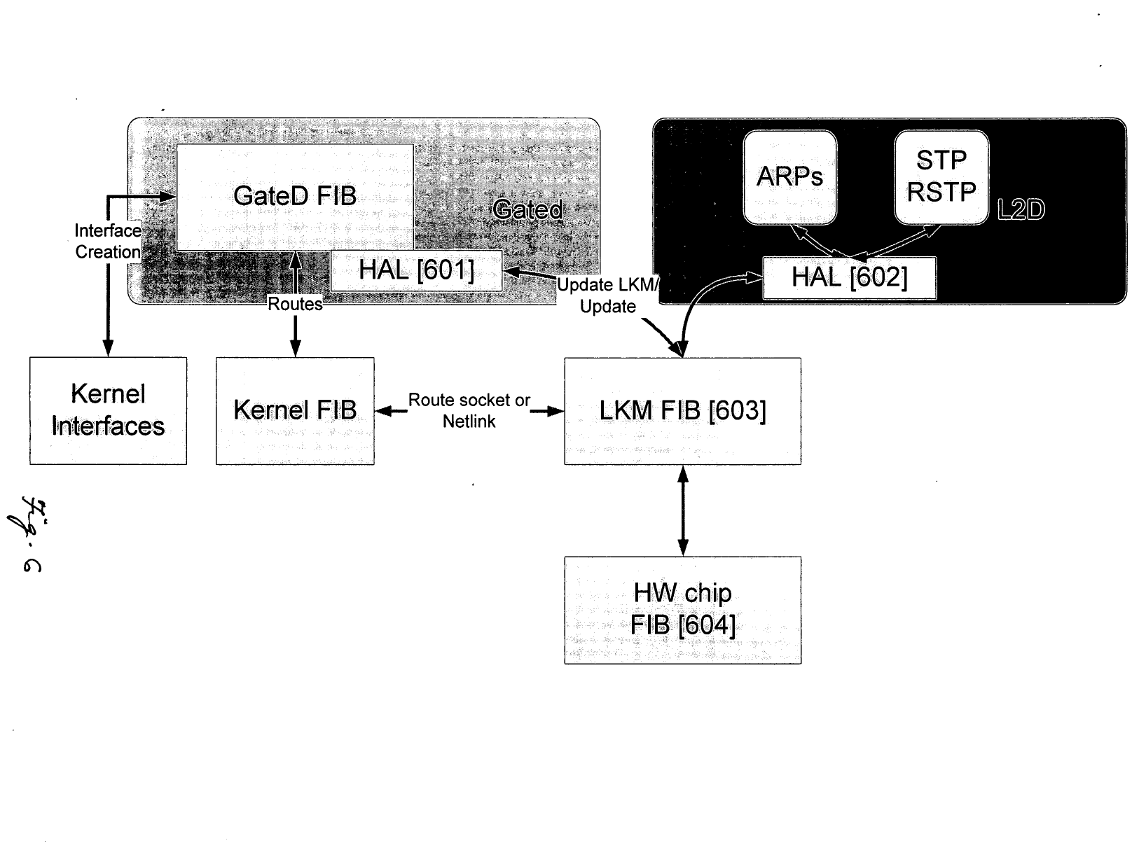

FIG. 7 is a diagram of a VLAN Manager APIs.

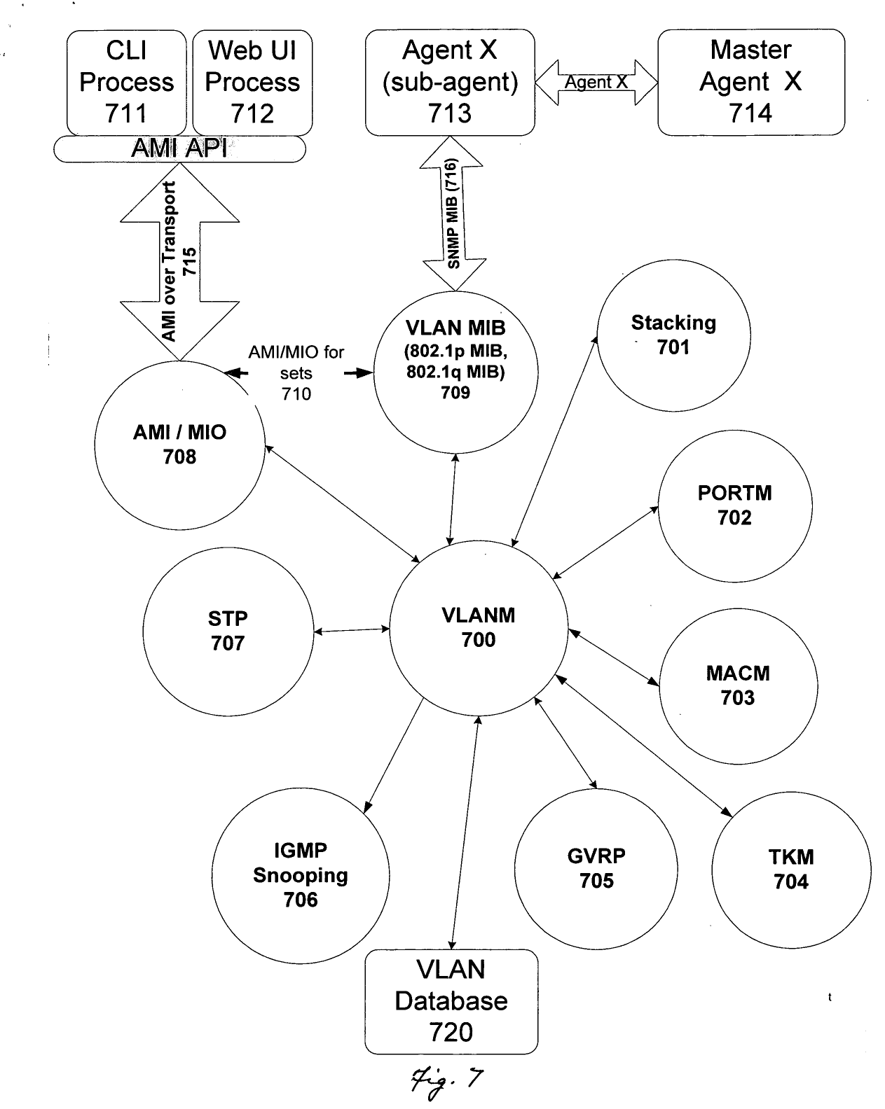

FIG. 8 is a diagram of a MAC Manager APIs.

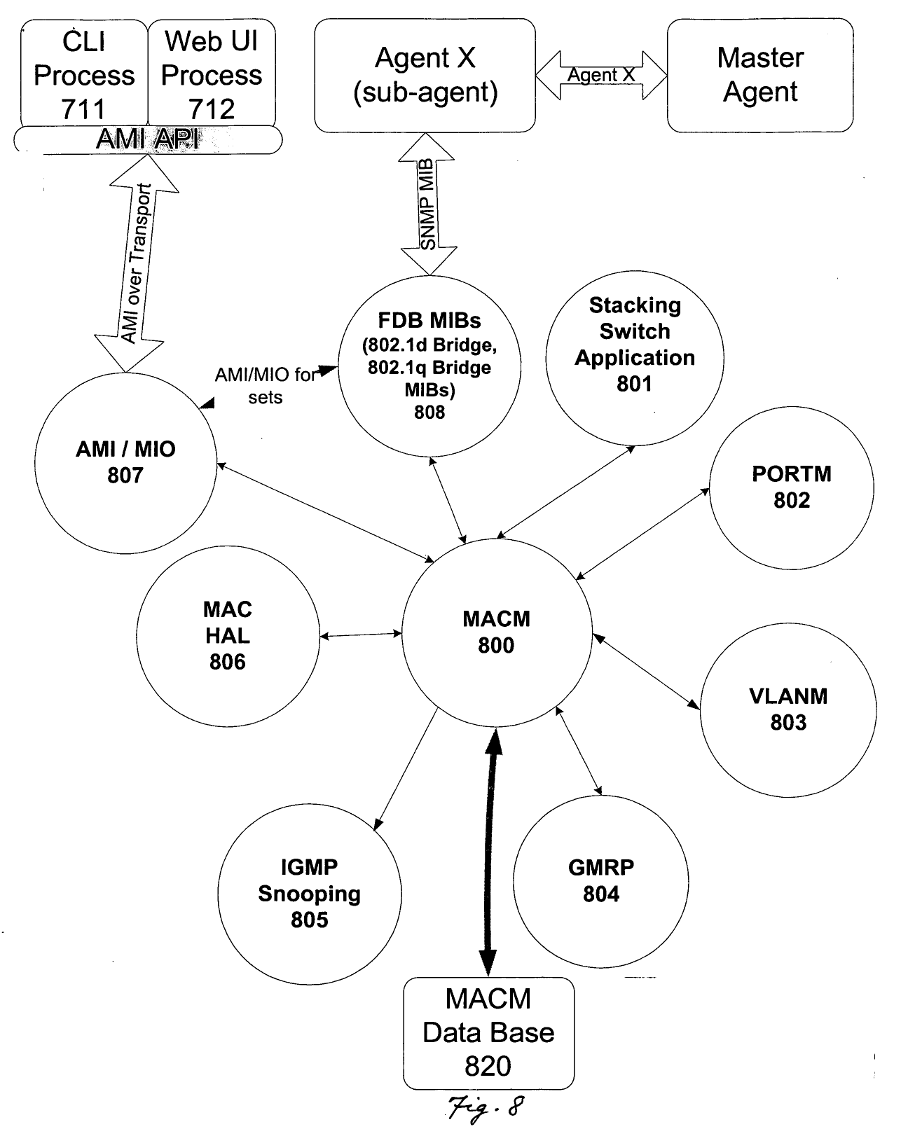

FIG. 9 is a diagram of a Port Manager APIs.

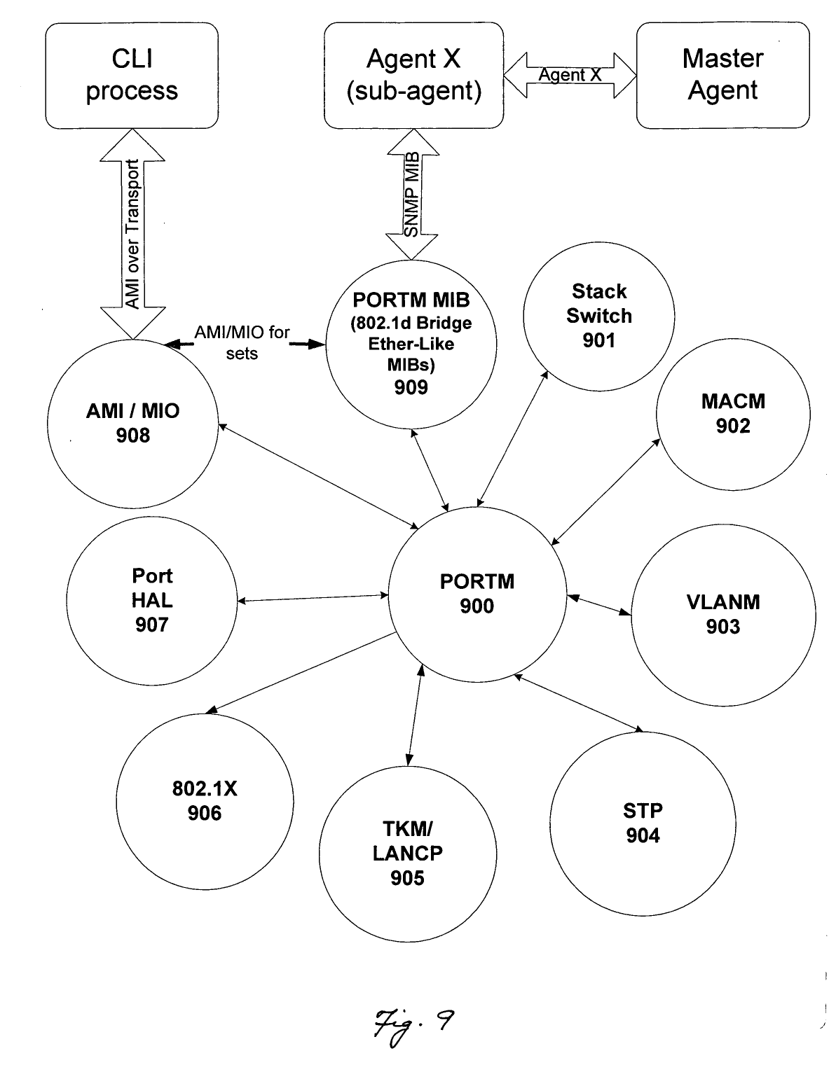

FIG. 10 is a diagram of a ccess keys for Logical Port and Physical Port Databases.

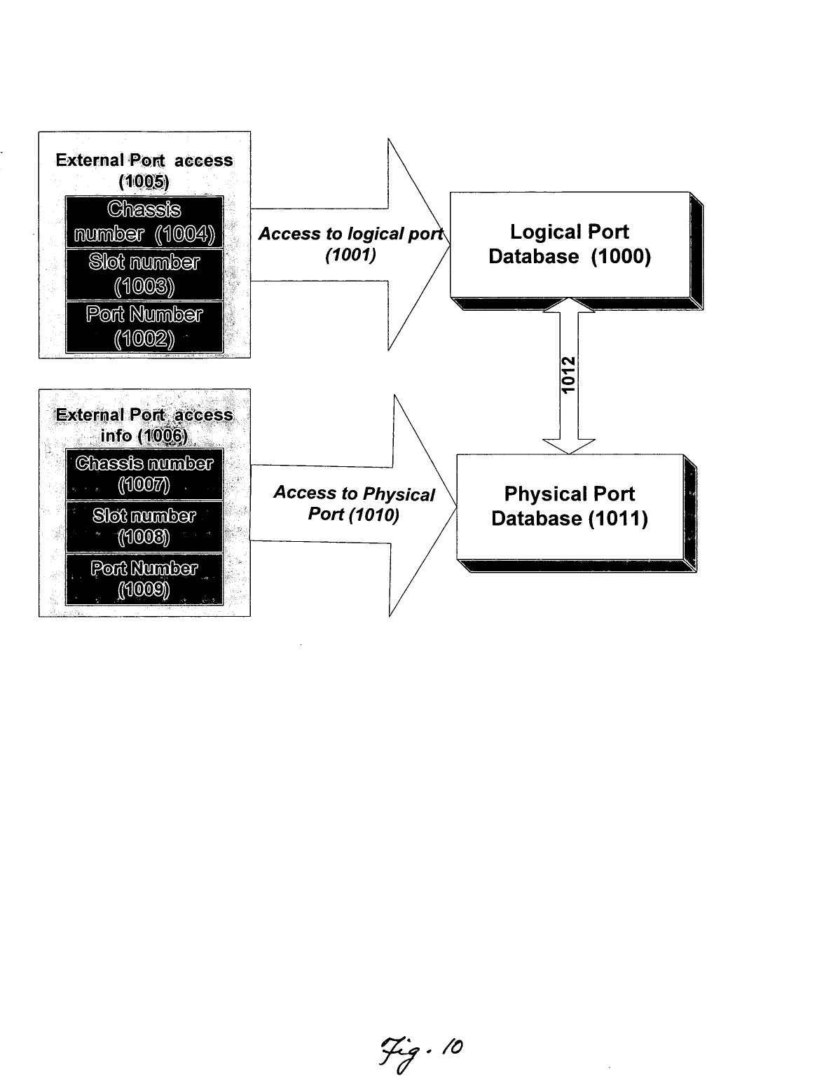

FIG. 11 is a diagram of a Logical Port mappings with and without trunking.

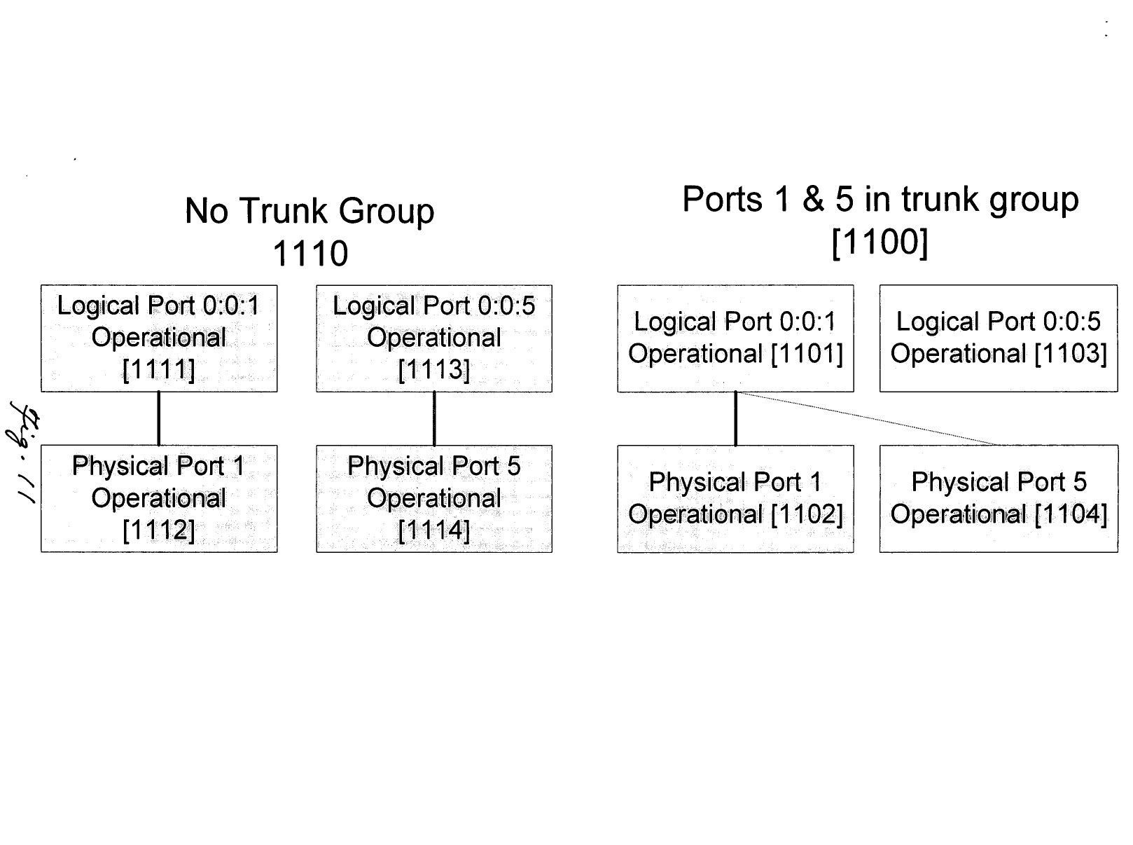

FIG. 12 is a diagram of a Stack Switch LSPV protocol with secure IDs in Hello.

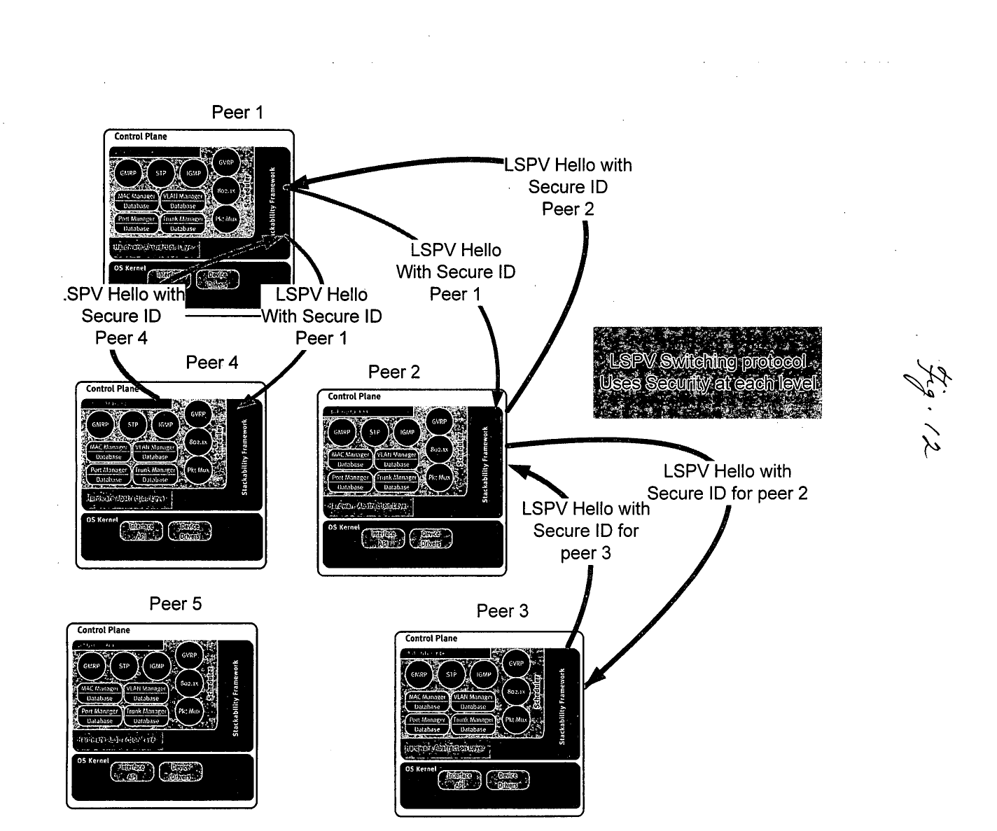

### DETAILED DESCRIPTION OF THE INVENTION

This inventions virtual switching environment includes methods for
Extensions to Virtual Routing Environment (VRE)'s Virtual Communication Environment (VCE) to create a virtual switch environment (VSE) for normal and stackable switches, and
Virtual Stackable Switch protocol based on the Link-State Path Vector algorithms and LSPV protocol mechanisms.
   Extensions to the Virtual Communication Environment for a Virtual Switch Environment

The extensions to Virtual Communication Environment (VCE) to create a Virtual Switch Environment (VSE) include application APIs for the switch application tasks that may operate within the switch units or between switch units across the VCE communication path. These switch application tasks are:
Manager applications (port, MAC addresses, VLAN, or Trunk/Link Aggregation),
Security applications (802.1x),
Layer 2 protocol (GMRP, GVRP, STP, RSTP, MSTP),
Layer 3 snooping (IGMP, PIM, DHCP)

Diagram 2 shows one embodiment of the Virtual Switching Environment (VSE) with these virtual application tasks.

Diagram 3 shows how the Virtual Switching Environment running the layer 2 application tasks operate as a switch. The Management tasks [port [301], MAC [302], VLAN [303], trunk [304]] operate above the HAL interface [305]. The protocol tasks utilize the information from the management task via the VSE APIs. One embodiment of the protocol tasks are GMRP [306], STP/RSTP [307], and GVRP [309]. The security tasks are 802.1x[310], and the layer 3 snooping [308]. The inter-VSE communication is shown in vrClientAPI [311], and the vrIPC[312].

Existing switches technology allows hardware chassis or ports or logical stacking groupings to register with a switching task. The VCE goes beyond existing switch technology to allow application tasks running in VSE processes to communicate. The virtual switch processes and their virtual tasks (vtasks) may communicate any form of hierarchy. Diagram 4 illustrates this point with two of the possible hierarchies: hierarchical master-slave [401], and peer [402].

The APIs for application processes in the Virtual Switch Environment (VSE) allow portions of the processing may be transferred to another process. For example, the 802.1x API allows communication with a remote radius server from any of the 802.1x tasks.

The API between any Virtual Switch Engine (VSE) tasks and the physical hardware is via the Hardware Abstraction Layer (HAL) API. The HAL API controls the ports and the data flow from the ports. HAL API commands may be sent across the VSE environment to remote VSE task that control hardware linked to this virtual switch.

Diagram 5 illustrates one embodiment of the HAL control for a switch. Port task in the VSE [501] uses the HAL Port Access API [504] to control the Loadable Kernel Module (LKM) interface [508] to the device drivers for the hardware ware. In the same manner, the MAC manager application task [502] in the VSE uses the Port Access HAL for MACs [505] that in turn sets information the LKM for the Port Access (PA) [508]. The Packet Multiplexing [503] task sets the via the HAL Packet Access API [506] that in turn sets information in the LKM for the Packet Data Access (PDA) to the control plane or other modules.

In the same way, after the control plane switching processes (STP, RSTP, MSTP) calculate the forwarding egress points to the switch, the VSE process updates via the HAL process [602]. Layer 3 forwarding table entries are also added to the hardware via the HAL process [601]. In some embodiments, this may be added via a loadable kernel module [603].

The manager application task APIs have
a Virtual LAN manager (VLANM) with a VLAN Database,
a MAC layer Manager (MACM) with a MAC Database (MAC DB),
A Port Manager (PORTM) with a Port Database (Port DB),
A Link Aggregation Process and Link Trunking manager (TKM) with a Link Aggregation Control Database (LAC DB),

The VLAN manager includes canonical interfaces for the other managers (Port Manager, MAC manager), the AMI/MIO task, the VLAN MlBs, the IGMP snooping task, the GVRP protocol, the Spanning tree protocols (STP, RSTP, MSTP) and the stackable switch application. The VLAN manager also has a VLAN Data Base associated with it [diagram 7 item 720].

Diagrams 7 show the APIs between the VLAN Manager virtual task [700] to:
stacking application [701],
managers (Port manager [702], MAC Manager [703], Trunking/Aggregation manager [704],
protocols (GVRP [705], STP [707]),
Snooping (IGMP snooping [706])
time critical management applications (AMIIMIO) [708] that in turn is accessed by SNMP sets [716] or CLI processes [711], or Web UI process [712],
SNMP Agent X interface [716], and the
VLAN Database [720].

Diagram 8 shows the APIs for the MAC Manager application (800) and it's associated MAC Database (820). The MAC managers has canonical interfaces for the other managers (VLAN Manager[803], Port Manager [802]), the GMRP protocol[804], IGMP Snooping[805], the MAC HAL interface[806], the AMI/MIO interface [807], the Forwarding Data Base MlBs [808], and the stackable switch application [801].

Diagram 9 shows the interfaces between the Port manager [900] and other layer 2 switching tasks including the TKM task.

Virtual Stackable Switch Protocol

The virtual switching protocol stores databases regarding each virtual switch that contain:
Virtual switch unit identity,
Virtual Switch VSE IPC method and IPC end-point identity,
Virtual Tasks running on software applications using VSE communication
Virtual Switch mapping to hardware chassis and port configuration,
Virtual Switch stacking information (HAL, hardware, and software application stacking information)
Virtual Switch unit mapping from logical to physical ports,
Virtual Switch groupings of ports for trunks, VLANs or management ports.
Forwarding rules for inter-switch hardware set-up,
Forwarding Path Calculation methods, and
Forwarding Paths and hardware mapping.

The Physical port database can be access by chassis, slot or port number or by reference from the logical database. The Logical port database can also be accessed by chassis, slot and port number. Diagram 10 shows the physical and logical port databases and their access keys. The port mappings between the physical and logical are one-to-one unless trunking or link aggregation is used. If one logical port maps to two physical ports, the logical port identifier that would have mapped to these ports is unused. This method of number allows swapping between trunked and non-trunked ports.

Diagram 11 shows the mapping between logical and physical ports with and without trunking. For the trunking case, Port 1 [1102] and Port 5 [1104] are mapped to logical Port 1 [1101], Logical port 5 [1103] stays idle. In the non-trunking case [1110], logical Port 1 [1111] maps to physical port 1 [1112]. Logical port 5 [1114] maps to physical port [1113].

The secure virtual stackable switch protocol provides:
Virtual stackable switch process discovery,
Physical stackable switch process discovery,
Election of Master, Back-up Master, and standby units,
Keepalive and heartbeat monitor mechanisms between Layer2 switch units,
Synchronization of state between Layer2 units (master, back-up-master and stand-by units), and
Failure detection and watchdog services per unit,

The VSE virtual stackable switch protocol utilizes a protocol path between the Layer 2 units via the Virtual communication environment VSE environment for control traffic for the stacking framework. Bringing up a connection between two virtual stackable switch control planes brings up a physical and logical link. The physical link indicates may be pass from the device drivers via the HAL to a virtual stackable switch or the manager for un-assigned hardware. At this point, hardware information is stored in the database and shared among all attached Virtual Switching Entities.

The logical links between two Virtual stackable switches depend on the configuration of the vrEngines. These Virtual Switches can utilize the VSE environment and protocol to create hierarchical network of processes for switches. Individual interaction can be in “master-slave” relationships or in a peer-to-peer structure. Diagram 4 indicate the differing types of hierarchies support by the Virtual Switching Environment and the Virtual Stackable switch protocol.

The logical link between two VSE stackable switch processes may be brought up or down in multiple stages depending on what physical means connect the two processes.

One embodiment of this invention allows:
the first stage of bring up can be determined by a light-weight hello protocol such as the IETF BFD protocol,
the second stage of bringing up to be determine by the secure peer exchange of the Link State Path Vector Protocol (based on link-state path vector algorithms),
the third stage being an exchange about initial path calculation policy, and the
the four stage being the full distribution of switching database information.

A second embodiment of this invention allows the first stage of bring up to be one stage:
Stage 1: Link state path vector hello serves as a light-weight hello, and
Stage 2: Upon exchanging secure hello, the two VSE stackable switches immediately exchange databases and calculate paths based on pre-shared policy.

A third embodiment of this invention allows initial distribution of FIB information between two switches in a master-slave relationship:
Stage 1: light hello protocol such as IETF BFD to determine if the two processes can see one another,
Stage 2: Secure Link-State Path Vector hello exchange and Master-Slave status set between two peers.
Stage 3: Link State Path Vector queues the FIB synchronization protocol to run in parallel to update current state of FIB from master to the slave,
Stage 4: Link State Path Vector passes topology information to/from the master and slave; FIB information is restricted to the master.

As these embodiments indicate, the virtual stacking protocol runs with a link state path vector algorithm allowing hierarchy and opacity at certain points in the hierarchy. The opacity allows a virtual switch participating as a master at one level to be a slave at the next higher level. The virtual switch stacking algorithms can allow opacity to treat the two levels as two separate interaction in the protocol.

The virtual stacking framework allows the communication between the stackable layer 2 units may utilize either a stackable switch protocol or a combination of the stackable switch protocol and other hello protocols (such as BFD or FIB synchronization protocol) or FIB synchronization protocols.

The LSPV Stackable Switch protocol uses a LSPV peer mesh to create groups of peers or hierarchies of peers. This protocol uses network-component within the protocol to reduce the flooding of information between master, back-up master, and slave.

It operates within the stackable framework to determine best path for flooding of the information based on the stackable framework and bandwidth of the inter-connection. Diagram 12 shows the operation of Stackable Switch Protocol to create a web of trust as a LSPV protocol. Diagram 12 shows that each of the Virtual Stackable Switch units provide a Secure ID, a normal ID, and other hello information (for security, topology or policy).

To build this web of trust may pass or pre-configure the following information that is used in creating the secure web of peers.
a Policy domain—administrative policy domain for this switch's management,
Security hierarchy identifier—who is my secure signature hierarchy
Secure ID—my security identification information,
Levels in hierarchy for security and peer pathways,
Peer status: master-slave, or peer-to-peer, and domain, and
Forwarding Capabilities—transit forwarding or end-point forwarding.

The actual securing method may utilize the secure components directly to create the security keys or as hints to start the 802.1x securing process.

1. A computer network system comprising:
a plurality of virtual switches, each of the plurality of virtual switches comprising computer network software, wherein the plurality of virtual switches are in communication via an inter process communication protocol, and wherein each of the virtual switches is operative to perform layer 2 switching functions on network packets processed by the virtual switch, wherein the plurality of virtual switches are arranged in a topology selected from one of a peer-to-peer architecture and a master-slave hierarchy;
a plurality of processors, wherein the plurality of processors exchange the network packets via local buses and distributed networks, and wherein the plurality of virtual switches may reside on any one or more of the plurality of processors, and the inter process communication protocol is invariant upon a relocation of the plurality of virtual switches amongst the plurality of processors.
